(19) United States
(12) Patent Application Publication
(10) Pub. No.: US 2014/0165311 A1
(43) Pub. Date: Jun. 19, 2014

(54) Child's Toothbrush Facilitating Proper Brushing

(71) Applicant: PATENT PLAYGROUND LLC, Jupiter, FL (US)

(72) Inventor: Joshua Donegan, Jupiter, FL (US)

(73) Assignee: PATENT PLAYGROUND LLC, Jupiter, FL (US)

(21) Appl. No.: 13/720,840

(22) Filed: Dec. 19, 2012

(51) Int. Cl. A61C 17/16

(52) U.S. Cl. CPC A61C 17/16
USPC 15/22.1

(57) ABSTRACT

The present invention provides a child's toothbrush that encourages the user to brush his or her teeth more often and for at least a proscribed minimum period of time per brushing. The present invention accomplishes this by providing a tangible, user perceptible reward at the end of a suitably long and well performed brushing sequence. In one embodiment of the present invention, the user is rewarded with a brief shower of bubbles blown from the handle of the device. In other embodiments, colored lights, music or sound, and/or encouraging textual or graphical messages reward the user.

### CROSS-REFERENCE TO RELATED APPLICATIONS

This application takes benefit of U.S. Provisional App. 61/579,988 dated Dec. 23, 2011 which is incorporated herein by reference.

### FIELD OF THE INVENTION

This invention relates generally to oral hygiene, and more particularly to electrically powered toothbrushes.

### BACKGROUND OF THE INVENTION

Poor oral hygiene is common among young children. In many cases, children fail to brush on a regular basis because they find it to be a chore and, therefore, lack motivation to do so. In other cases, children do brush on a regular basis but fail to spend sufficient time actually brushing. It is accepted that the time required for adequate brushing is approximately two minutes. See: Kelly Soderlund, American Dental Association, Take Two Minutes to Brush, http://www.ada.org/news/7484.aspx (Aug. 16, 2012).

In an attempt to address the general challenge of improving oral hygiene in children, manufacturers have developed oral hygiene products that appeal specifically to children. For example, children's toothpaste is often flavored and colored to resemble some type of candy. Also, children's toothbrushes are often made in the shape of action figures, animals, etc. Some toothbrushes display colorful lights while brushing. See: U.S. Pat. No. 6,029,304 (“Light Interactive Toothbrush”). At least one toothbrush in the prior art combines an action figure with a light that flashes for a fixed period of time to encourage children to brush their teeth for that fixed period of time. Although children may prefer such products over adult oral hygiene products, such products have little measurable effect in terms of increasing the frequency with which children brush their teeth, much less length of time that a child brushes its teeth.

What is needed, therefore, is a device that encourages children to brush their teeth more often by offering a positive stimulus or reward for doing so. What is also needed is a device that encourages children to spend enough time brushing their teeth when they do brush.

### SUMMARY OF THE INVENTION

It is an object of the present invention to provide a child's toothbrush that encourages the user to brush their teeth more often and for at least a minimum amount of time, preferably two minutes per brushing. The present invention accomplishes this by providing a tangible, user perceptible reward at the end of a successful brushing sequence of the proscribed length of time. In one embodiment of the present invention, the user is rewarded with a brief shower of bubbles blown from the handle of the device. In alternative embodiments of the present invention, these bubbles may be accompanied by colored lights and/or various sounds. In still other embodiments, colored lights and various sounds alone or in combination may be produced. In another embodiment, a textual or graphic message may be displayed to the user.

The device generally comprises a power source such as a battery, a control circuit, a sensor, and an output device. The power source is electrically connected to supply electrical power to the control circuit, the sensor, and the output device. The sensor is used to determine if, when, and/or how the toothbrush is being used. This sensor is also electrically connected to the aforementioned control circuit. The control circuit uses input from the sensor to determine if the user has used the toothbrush in the predetermined pattern for the predetermined time. The control circuit is electrically connected to the output device such that the control circuit causes the output device to begin to function. The output device may be any device that performs one or more user perceptible actions. Typical user perceptible actions include, but are not limited to, blowing bubbles, flashing colored lights, playing sounds, or displaying textual and/or graphical messages.

In the first embodiment of the present invention, the user picks up the toothbrush, applies a measure of toothpaste to the bristles, and begins to brush his or her teeth. The sensor detects the spatially repetitive motion of the toothbrush as the user brushes and communicates an electrical signal to the control circuit to indicate this motion. In one embodiment, the toothbrush may determine if the user has manipulated the brush in a specific spatially repetitive manner for a predetermined period of time. Such spatially repetitive use would be expected to occur when using the toothbrush to repetitively brush the teeth in a back-and-forth or up-and-down manner. If the user brushes his or her teeth for a predetermined period of time, for example two minutes, the control circuit communicates an electrical signal to a bubble generator causing it to generate a stream of bubbles for a predetermined period of time. This stream of bubbles serves as a reward to the user for brushing his or her teeth for the proper amount of time. Other embodiments of the present invention provide different user perceptible rewards.

### BRIEF DESCRIPTION OF THE DRAWINGS

FIG. 1 is a block diagram showing a toothbrush according to a first embodiment of the present invention.

FIG. 2 is a block diagram showing toothbrush according to a second embodiment of the present invention.

FIG. 3 is a block diagram showing toothbrush according to a third embodiment of the invention.

FIG. 4 is a block diagram showing toothbrush according to a fourth embodiment of the invention.

FIG. 5 is a block diagram showing toothbrush according to a fifth embodiment of the invention.

### DETAILED DESCRIPTION OF THE INVENTION

The present invention improves over the prior art by providing a toothbrush that detects when it is being used and outputs a user perceptible action when a predetermined operating condition is met.

In the following description, numerous specific details regarding possible componentry are set forth (e.g., motion detectors, motion sensors, touch sensors, audio devices, lighting devices, motors, blowers, bubble generators, etc.) in order to provide a thorough understanding of the invention. Those skilled in the art will recognize, however, that the invention may be practiced apart from these specific details. In other instances, details well known and widely used in the process of manufacturing toothbrushes (e.g., plastic injection molding, various techniques for attaching bristles, techniques for assembling electronic components, etc.) and miscellaneous components have been omitted, so as not to unnecessarily obscure the present invention.

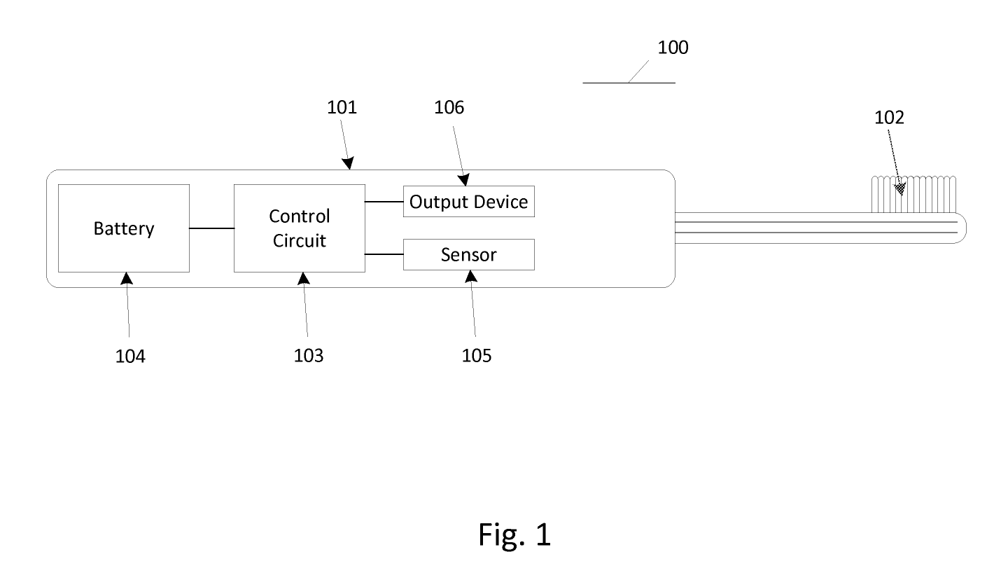

Turning now to FIG. 1 a first embodiment of toothbrush 100 includes a handle 101 and a bristled head 102. Bristled head 102 may be permanently attached to handle 101 or may be detachable such that bristled head 102 is replaceable. Handle 101 comprises control circuit 103, a power source such as a battery 104, a sensor 105, and an output device 106. Control circuit 103 is electrically coupled to battery 104, sensor 105, and output device 106. Control circuit 103 monitors the state of sensor 105 to determine if, when, and/or how toothbrush 100 is being used. After control circuit 103 determines that the user has completed a predetermined brushing routine, control circuit 103 actuates output device 106.

Determining if the user has completed a predetermined brushing routine may be done in many ways. The process may be as simple as actuating output device 106 some fixed, predetermined time after sensor 105 initially detects the presence of the user. This first step, detecting the presence of a user, may be done either automatically (e.g., by detecting an orientation change in toothbrush 100) and/or manually (e.g. wherein sensor 105 is a simple pushbutton switch that the user merely actuates). The second step, determining when to actuate output device 106, may also be done in many ways. For example, output device 106 may be actuated only after control circuit 103 counts a predetermined number of manual, spatially repetitive oscillations as recorded by sensor 105 as the brush is used. Similarly, output device 106 may be actuated only after brushing as sensed by sensor 105 has occurred for a fixed, predetermined period of time. In such an embodiment, if the user was to remove the toothbrush from the mouth temporarily, the time already spent brushing might be recorded and additional time would not be recorded until the user began brushing again. Only after the total amount of time spent brushing exceeds the predetermined period of time to actuate output device 106, would control circuit 103 actuate output device 106. Alternately, if the user removes the toothbrush from the mouth permanently before the proscribed brushing period has elapsed, any prior time spent brushing would be discarded thus requiring the user to complete an entire brushing cycle before control circuit 103 subsequently actuates output device 106.

Sensor 105 may be any type of device that could be used to detect the manual use of toothbrush 100. For example, sensor 105 may be any type of known mechanical motion or force detecting device including, but not limited to: 1) An accelerometer; 2) Various types of motion sensing switches such as a pendulum type orientation sensor, a multi-pole mercury switch, or a rolling ball switch; 3) One or more inertial modules; 4) A simple pushbutton switch; and/or, 5) A microelectromechanical system (MEMS). Similarly, sensor 105 may also be a stress sensor (e.g., a thin-film resistor, a piezoresistive sensor, etc.) capable of detecting mechanical stress applied to the handle and/or neck of toothbrush 100 as the user brushes. Finally, in some embodiments of the present invention, sensor 105 may be a contact sensor (e.g. an optical sensor, a thermal sensor, a conductive fluid level type sensor, or a capacitive touch sensor, etc.) capable of detecting that a user has come into contact or is in contact with toothbrush 100.

Output device 106 represents any type of device that performs one or more user perceptible actions, including but not limited to: 1) Dispensing some enjoyable or recognizable substance; 2) Reproducing a variety of prerecorded sounds; 3) Flashing one or more colored light emitting diodes (LEDs) or lamps; and/or, 4) Displaying a graphical or textual message on a display device, such as an LCD. For example, output device 106 may be any type of motorized or electromechanical device that dispenses a substance into the user's mouth (e.g., flavored liquid, mouth wash, flavored foam, etc.) or dispenses other substances (e.g., bubbles or odoriferous compounds) into the air. Similarly, output device 106 may be an audio device that reproduces a prerecorded song, recorded digital message, and/or tones. Output device 106 may include a light emitting device (e.g., colorful LEDs or lamps) that flash in different spatial patterns and intensity. Similarly, output device 106 may be a display device capable of displaying textual or graphic messages such as an LCD. Such messages might include the number of spatially repetitive motions made during the last brushing session, the aggregate number of spatially repetitive motions made during all brushing sessions, and so on.

With the various possible sensors 105 and output devices 106 that may be used, control circuit 103 may perform operations that: 1) Need only be triggered by an initial input signal (e.g., actuating a simple pushbutton switch, sensing that a user has touched toothbrush 100, sensing a change in orientation of toothbrush 100, etc.); and/or, 2) Need continuously acquired sensor information (e.g., counting the number of spatially repetitive oscillations as the user uses toothbrush 100, counting the number of times mechanical stress is applied to the head of toothbrush 100 as the user brushes, and/or measuring the amount of time the head of toothbrush 100 is in the mouth, etc.). Control circuit 103 may further comprise non-volatile random access memory and/or working random access memory. This would allow control circuit 103 to perform certain useful tasks such as keeping a history of an individual's tooth brushing habits (e.g., frequency of brushing, regularity of brushing, time spent brushing, etc.). Such information would be beneficial in that an individual could keep track of their own habits or allow a parent to keep track of a child's brushing habits. Further, an ongoing, continuous history of good brushing episodes could be used to cause increasingly more appealing or complex output responses. For example, the first time the child brushes properly the output device might perform a single rewarding operation (e.g., blows bubbles out of the handle, plays an encouraging message, plays a brief light/sound show, etc.) after the brushing session is completed. Subsequently, if the child brushes properly during the following brushing session, the output becomes increasingly more elaborate, and so on. By the same token, if the child fails to brush properly or skips a brushing session, the next output might be less elaborate. An increasingly pleasant feedback experience coupled with gentle negative reinforcement could provide the child with motivation to continue consistently good bushing performance.

In a variation of this embodiment, output device 106 may perform one or more operations (e.g., plays some type of song, message, and/or tone) in real-time as long as motion is detected.

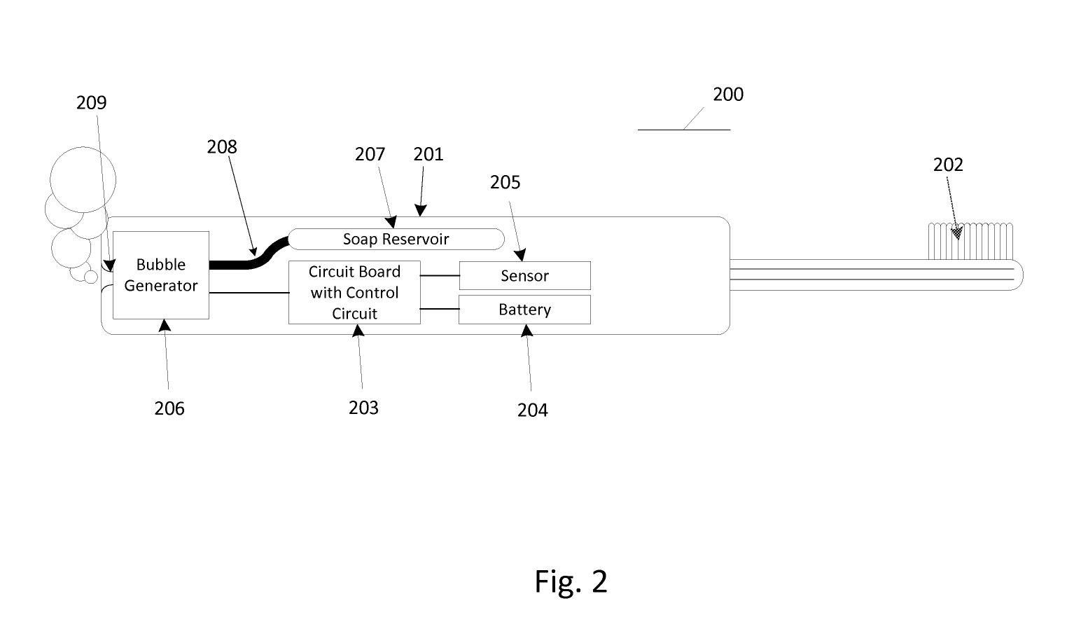

Turning now to FIG. 2, a second embodiment of toothbrush 200 is shown. Toothbrush 200 includes handle 201 and bristled head 202. Handle 201 includes circuit board with control circuit 203, battery 204, sensor 205, bubble generator 206, soap reservoir 207, soap tube 208, and bubble outlet port 209. Circuit board with control circuit 203 is electrically connected to battery 204, sensor 205, and bubble generator 206. Bubble generator 206 is of the type well known in children's toys capable of blowing a stream of bubbles. Bubble generator 206 typically comprises an electric motor with fan or impeller providing a stream of air, a bubble forming chamber though which the stream of air flows, and one or more internal bubble forming structures, such as a circular wand insinuated in the central core of the bubble forming chamber or a pleated surface covering the inner aspect of the bubble forming chamber. Bubble generator 206 is fluidically coupled to soap reservoir 207 via soap tube 208 so as to receive soap from soap reservoir 207 for the production of bubbles. Soap may be delivered from soap reservoir 207 to bubble generator 206 passively (e.g. by gravity) or actively (e.g. by a venturi effect created in the bubble forming chamber due to air being propelled through it). Bubble generator 206 is also atmospherically coupled to bubble outlet port 209 so as to dispense bubbles therefrom. When bubble generator 206 is activated, its electric motor with fan or impeller is activated propelling a stream of air through its bubble forming chamber. Bubble solution is drawn into the bubble forming chamber where it coats the one or more internal bubble forming structures inside the bubble forming chamber. Air is entrained into the bubble solution forming a stream of bubbles which are emitted via bubble outlet port 209. Bristled head 202 may be permanently attached to handle 201 or may be detachable such that bristled head 202 is replaceable. The soap from which the bubbles are made may optionally be hypoallergenic soap. In this embodiment, soap reservoir 207 is not refillable, thus making it necessary to acquire a new toothbrush when the bubble solution in soap reservoir 207 is depleted.

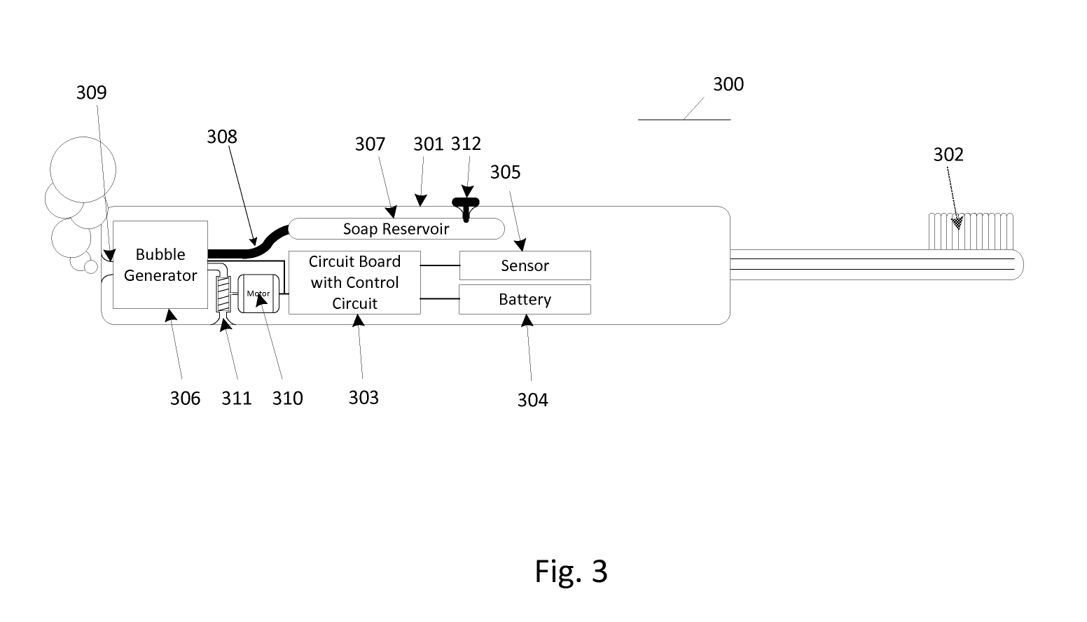

Turning now to FIG. 3, a third embodiment of toothbrush 300 is shown. Toothbrush 300 includes a handle 301 and a bristled head 302. Handle 301 includes a circuit board with control circuit 303, battery 304, sensor 305, bubble generator 306, soap reservoir 307, soap tube 308, and bubble outlet port 309. These components are functionally equivalent to similarly named components in the second embodiment of the present invention. In this embodiment, handle 301 further comprises blower motor assembly 310, air duct 311, and soap reservoir access 312 with plug. Circuit board with control circuit 303 is electrically connected to battery 304, sensor 305, bubble generator 306, and blower motor assembly 310. Bubble generator 306 is atmospherically coupled to air duct 311 and fluidically coupled to soap reservoir 307 via soap tube 308 so as to receive air and soap, respectively, from which bubbles are made. In this embodiment, air enters through air duct 311 and is accelerated by blower motor assembly 310 before being injected into bubble generator 306. Bubble generator 306 is atmospherically coupled to bubble outlet port 309 so as to dispense bubbles therefrom. Soap reservoir 307 may be refilled with soap via reservoir access 312 by removing the aforementioned plug. Although not shown, blower motor 310 may be mechanically coupled to bubble generator 306 so as to provide mechanical power thereto in lieu of a separate electric motor in bubble generator 306. This third embodiment has two advantages over the second embodiment: 1) A toothbrush 300 constructed in accordance with the third embodiment produces a more vigorous stream of bubbles than the device of second embodiment; and, 2) A toothbrush 300 constructed in accordance with the third embodiment may be refilled with additional, or different, bubble soap when empty. As before, bristled head 302 may be permanently attached to handle 301 or may be detachable such that bristled head 302 is replaceable. Similarly, the soap from which the bubbles are made may optionally be hypoallergenic soap.

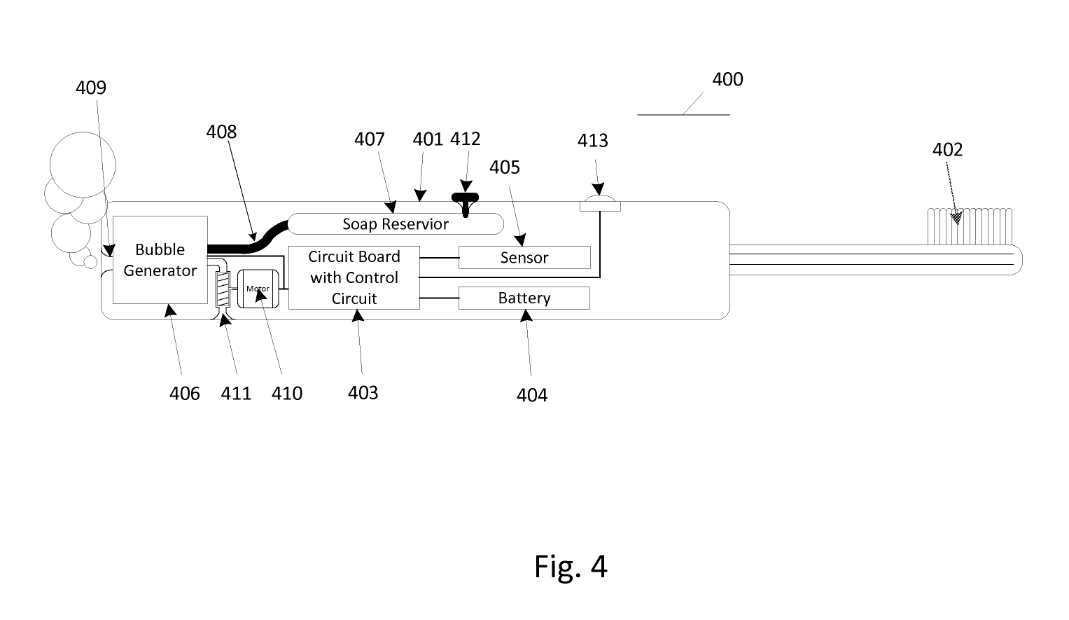

Turning now to FIG. 4 a fourth embodiment of toothbrush 400 is shown. Toothbrush 400 includes a handle 401 and a bristled head 402. Handle 401 includes a circuit board with control circuit 403, battery 404, sensor 405, bubble generator 406, soap reservoir 407, soap tube 408, bubble outlet port 409, blower motor assembly 410, air duct 411, and soap reservoir access 412 with plug. These components are functionally equivalent to similarly named components in the second and third embodiments, respectively, of the present invention. In this embodiment, handle 401 further includes a manual pushbutton switch 413, or equivalent. Circuit board with control circuit 403 is electrically connected to battery 404, sensor 405, bubble generator 406, blower motor assembly 410, and manual pushbutton switch 413. Bubble generator 406 is atmospherically coupled to air duct 411 and fluidically coupled to soap reservoir 407 via soap tube 408 so as to receive air and soap, respectively, from which bubbles are made. In this embodiment, air enters through air duct 411 and is accelerated by blower motor assembly 410 before being injected into bubble generator 406. Bubble generator 406 is also atmospherically coupled to bubble outlet port 409 so as to dispense bubbles therefrom. Soap reservoir 407 may be refilled with soap via reservoir access 412 by removing the aforementioned plug. Although not shown, the motor of blower motor assembly 410 may be mechanically coupled to bubble generator 406 so as to provide mechanical power thereto in lieu of a separate electric motor in bubble generator 406. Bristled head 402 may be permanently attached to handle 401 or may be detachable such that bristled head 402 is replaceable. In this particular embodiment, sensor 405 is a motion sensing sensor (e.g., an accelerometer, a pendulum type orientation sensor, a multi-pole mercury switch, a rolling ball switch, one or more inertial modules, and/or a microelectromechanical system (MEMS)) such that circuit board with control circuit 406 not only detects the presence of the user but also counts brush strokes and/or measures other spatially repetitive motion characteristics indicative of brushing performance. In this embodiment, manual pushbutton switch 413 is used to initiate the process of counting brush strokes and/or measuring other spatially repetitive motion characteristics indicative of good brushing performance.

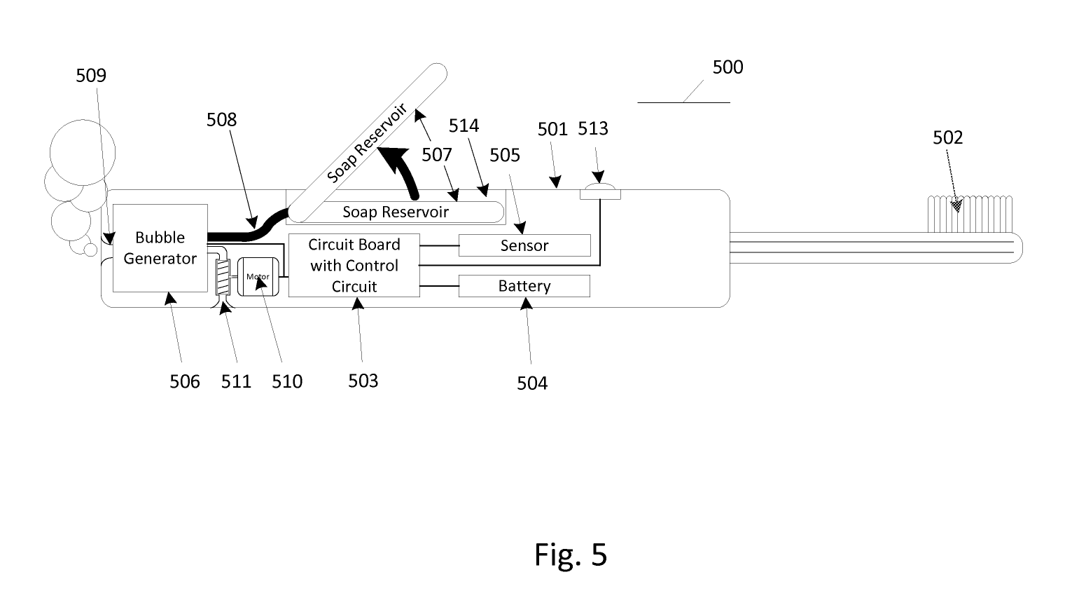

Turning now to FIG. 5 a fifth embodiment of toothbrush 500 is shown. Toothbrush 500 includes a handle 501 and a bristled head 502. Handle 501 includes a circuit board with control circuit 503, battery 504, sensor 505, bubble generator 506, soap reservoir 507, soap tube 508, bubble outlet port 509, blower motor assembly 510, air duct 511, and manual pushbutton switch 513, or equivalent. These components are functionally equivalent to similarly named components in the second, third, and fourth embodiments, respectively, of the present invention. In this embodiment, handle 501 further includes a recess 514 allowing access to soap reservoir 507. Circuit board with control circuit 503 is electrically connected to battery 504, sensor 505, bubble generator 506, blower motor assembly 510, and manual pushbutton switch 513. Bubble generator 506 is atmospherically coupled to air duct 511 and fluidically coupled to soap reservoir 507 via soap tube 508 so as to receive air and soap, respectively, from which bubbles are made. In this embodiment, air enters through air duct 511 and is accelerated by blower motor assembly 510 before being injected into bubble generator 506. Bubble generator 506 is also atmospherically coupled to bubble outlet port 509 so as to dispense bubbles therefrom. Recess 514 allows the user to remove soap reservoir 507 from handle 501 when it is empty and replace it with a full one. Although not shown, the motor of blower motor assembly 510 may be mechanically coupled to bubble generator 506 so as to provide mechanical power thereto in lieu of a separate electric motor in bubble generator 506. Bristled head 502 may be permanently attached to handle 501 or may be detachable such that bristled head 502 is replaceable. In this particular embodiment, sensor 505 is a motion sensing sensor (e.g., an accelerometer, a pendulum type orientation sensor, a multi-pole mercury switch, a rolling ball switch, one or more inertial modules, and/or a microelectromechanical system (MEMS)) such that circuit board with control circuit 506 not only detects the presence of the user but also counts brush strokes and/or measures other spatially repetitive motion characteristics indicative of brushing performance. In this embodiment, manual pushbutton switch 513 is used to initiate the process of counting brush strokes and/or measuring other spatially repetitive motion characteristics indicative of good brushing performance.

Those skilled in the art will recognize that these and other brushing performance characteristics may be detected, measured, stored, and monitored using numerous equivalent techniques and components and that all such techniques and components are implicitly included within the spirit and scope of the present invention. Similarly, those skilled in the art will recognize that numerous alternative output devices other than those explicitly described are available to provide one or more pleasant or informative stimuli to the user and that all such output devices are implicitly included within the spirit and scope of the present invention.

Also, those skilled in the art will recognize that motorized electric toothbrushes are well known in the prior art. While some of the embodiments of the present invention comprise a motorized bubble generator and some additionally comprise a blower motor to pressurize atmospheric air before being injected into the bubble generator, it will be readily apparent that a single electric motor may perform both of these functions. Clearly, the same electric motor may be used to actuate a movable brushing head featuring one or more motions (e.g. rotation, sliding, and/or twisting). While these obvious variations are not described in detail to add clarity to the specification of the present invention, all such variations are also implicitly included within the spirit and scope of the present invention.

Further, in the second, third, fourth, and fifth embodiments bubble ports 209, 309, 409, and 509, respectively, are shown located at the end of handles 201, 301, 401, and 501, respectively. It will be specifically noted however that bubble ports 209, 309, 409, or 509, or any other output device for that matter, may be located at any point on the outer surface of the toothbrush including, without limitation, any point on the outer surface of handles 201, 301, 401, and 501 respectively, or the outer surface of bristled heads 202, 302, 402, and 502, respectively.

What is claimed is:

1. A toothbrush for facilitating proper brushing, comprising a handle in the form of an elongated cylinder with a tapered neck both of which are aligned along a longitudinal central axis with a bristled head at the distal end of said neck, wherein said handle is substantially hollow at the end opposite said bristled head, said handle internally further comprising:
a. a source of electrical power;
b. a sensor capable of detecting manual use of said toothbrush;
c. an output device capable of generating at least one user perceptible action; and,
d. a control circuit capable of determining from said sensor whether said toothbrush is being manually used and capable of causing said output device to generate said user perceptible action.

2. A toothbrush of claim 1 wherein said source of electrical power is a battery.

3. A toothbrush of claim 1 wherein said source of electrical power is a mains voltage to low voltage power adapter.

4. A toothbrush of claim 1 wherein said sensor is a switch.

5. A toothbrush of claim 4 wherein said switch is a motion sensing switch.

6. A toothbrush of claim 1 wherein said sensor is an accelerometer.

7. A toothbrush of claim 1 wherein said sensor is an inertial module.

8. A toothbrush of claim 1 wherein said sensor is a microelectromechanical system (MEMS).

9. A toothbrush of claim 1 wherein said sensor is a contact sensor capable of detecting that a user has come into contact with said toothbrush.

10. A toothbrush of claim 1 wherein said sensor is stress sensor that detects mechanical stress applied to the handle of said toothbrush.

11. A toothbrush of claim 1 wherein said output device dispenses a substance into the user's mouth.

12. A toothbrush of claim 1 wherein said output device dispenses a substance into the air.

13. A toothbrush of claim 1 wherein said output device is capable of audibly reproducing sound.

14. A toothbrush of claim 1 wherein said output device is capable of generating colored light.

15. A toothbrush of claim 1 wherein said output device is capable of generating a user perceptible textual message.

16. A toothbrush of claim 1 wherein said output device is capable of generating a user perceptible graphical display.

17. A toothbrush for facilitating proper brushing, comprising a handle in the form of an elongated cylinder with a tapered neck both of which are aligned along a longitudinal central axis with a bristled head at the distal end of said neck, wherein said handle is substantially hollow at the end opposite said bristled head, said handle internally further comprising:
a. a source of electrical power;
b. a sensor capable of detecting motion induced in said toothbrush by means of human use;
c. an output device capable of generating bubbles and dispensing them into the air;
d. a control circuit capable of determining from said sensor how long the user has continuously used said toothbrush in a spatially repetitive manner wherein said control circuit causes said output device to generate said bubbles after approximately 2 minutes of continuous use in a spatially repetitive manner.

18. A toothbrush of claim 17 wherein said control circuit causes said output device to generate said bubbles after approximately 1 minute of continuous use in a spatially repetitive manner.

19. A toothbrush of claim 17 wherein said output device also generates audible information.

20. A toothbrush of claim 17 wherein said output device also generates colored lights.

21. A toothbrush of claim 17 wherein said output device also generates a user perceptible textual message.

22. A toothbrush of claim 17 wherein said output device also generates a user perceptible graphical display.

23. A toothbrush of claim 17 in which said output device further comprises a non-refillable soap reservoir.

24. A toothbrush of claim 17 in which said output device further comprises a refillable soap reservoir.

25. A toothbrush of claim 17 in which said output device further comprises a replaceable soap reservoir.
